(19) United States
(12) Patent Application Publication
(10) Pub. No.: US 2007/0030691 A1
(43) Pub. Date: Feb. 8, 2007

(54) Backlight assembly and liquid crystal display having the same

(76) Inventors: Hyeon-yong Jang, Osan-si (KR); Seock-Hwan Kang, Suwon-si (KR)

Correspondence Address: CANTOR COLBURN, LLP, 55 GRIFFIN ROAD SOUTH, BLOOMFIELD, CT, 06002, US

(21) Appl. No.: 11/493,338

(22) Filed: Jul. 26, 2006

(30) Foreign Application Priority Data
Aug. 2, 2005 (KR) 10-2005-0070694

(51) Int. Cl. F21V 5/00

(52) U.S. Cl. 362/559

(57) ABSTRACT

A backlight assembly and liquid crystal display (LCD) having the same each include a surface light source including a lower substrate, an upper substrate joined to an outer circumference of the lower substrate and forming a discharge space, and an electrode formed on the joined upper and lower substrates, and at least one light source holder including an upper support plate, a lower support plate, and a sidewall for connecting the upper support plate and the lower support plate, and covering the electrode formed on the joined upper and lower substrates from a side of the joined upper and lower substrates.

This application claims priority to Korean Patent Application No. 10-2005-0070694, filed on Aug. 2, 2005, and all the benefits accruing therefrom under 35 U.S.C. §119, and the contents of which in its entirety are herein incorporated by reference.

### BACKGROUND OF THE INVENTION

1. Field of the Invention

The present invention relates to a backlight assembly and a liquid crystal display device (“LCD”) having the same, and more particularly, to a backlight assembly having a surface light source and a light source holder for supporting the surface light source, and an LCD having the backlight assembly.

2. Description of the Related Art

liquid crystal displays (“LCDs”) have become the mainstream of the current flat display devices. The liquid crystal display has two substrates provided with a plurality of electrodes, and a liquid crystal layer sandwiched between the substrates defining a liquid crystal (“LC”) panel. A voltage is applied to the electrodes to allow liquid crystal molecules of the liquid crystal layer to be rearranged to adjust the amount of light transmitted therethrough. Since the LCD is a non-emissive device, it cannot be used at a dark place. To overcome the problem and enable the LCD to be used at a non-illuminated place, a backlight assembly is provided to irradiate uniform light into the LC panel.

A conventional backlight assembly is generally classified as either an edge-type and a direct-type depending on the position of a light source. In the edge-type backlight assembly, the light source is positioned near the edges of the LC panel. Thus, the edge-type backlight assembly needs a light guiding plate to guide the light to the LC panel disposed over the light guiding plate. In contrast, the direct-type backlight assembly does not need a light guiding plate because the light source is disposed under the LC panel and the light from the light source is directly incident on the LC panel. As the size of a LCD increases, direct-type backlight assemblies have been used.

In the direct-type backlight assembly, the light from the light source is directly incident on the LC panel, distinctly revealing a dark portion and a bright portion. To overcome this problem, a thick optical plate or optical sheet, e.g., a diffusion plate or a diffusion sheet, is stacked over the light source. The optical sheet, however, increases the production cost and becomes an impediment to building thin LCDs. Recently, a surface light source has been developed as a light source which is a conventional direct-type and provides uniform light. Such a surface light source has been widely used as a light source, since it is less costly and thinner.

An electrode for forming a voltage is coated on the surface light source, and ultraviolet rays are generated in the surface light source using a discharge voltage applied to the electrode. However, the electrode becomes overheated by a continuously applied discharge voltage, and the heat from the electrode deteriorates the surface light source. In addition, the heat affects an upper liquid crystal panel assembly causing breakdown and malfunction of an LCD. Furthermore, since a bottom chassis disposed below the surface light source is made of metal, an arc may be generated between the electrode and the bottom chassis. The arc also causes breakdown and malfunction of the LCD.

### BRIEF SUMMARY OF THE INVENTION

The present invention provides a backlight assembly which prevents malfunction of an LCD caused by excessive heat and arcs.

The present invention also provides a liquid crystal display (“LCD”) having the backlight assembly.

The above stated aspects as well as other aspects, features and advantages, of the present invention will become clearer to those skilled in the art upon review of the following detailed description.

According to an exemplary embodiment of the present invention, a backlight assembly includes: a surface light source including a lower substrate, an upper substrate joined to an outer circumference of the lower substrate and forming a discharge space, and an electrode formed on the joined upper and lower substrates; and at least one light source holder including an upper support plate, a lower support plate, and a sidewall for connecting the upper support plate and the lower support plate, and covering the electrode formed on the joined upper and lower substrates from a side of the joined upper and lower substrates.

According to another exemplary embodiment of the present invention, a liquid crystal display including a backlight assembly includes a surface light source including a lower substrate, an upper substrate joined to an outer circumference of the lower substrate and forming a discharge space, and an electrode formed on the joined upper and lower substrates; at least one light source holder including an upper support plate, a lower support plate, and a sidewall for connecting the upper support plate and the lower support plate, and covering the electrode formed on the joined upper and lower substrates from a side of the joined upper and lower substrates, and a bottom chassis receiving the surface light source and the light source holder and disposed below the surface light source, and a liquid crystal panel assembly displaying an image using light emitted from the backlight assembly.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of an exemplary embodiment of a backlight assembly according to the present invention;

FIG. 2 is a cross-sectional view taken along line II-II′ of FIG. 1;

FIGS. 3A and 3B are cross-sectional views taken along line III-III′ of FIG. 1;

FIG. 4 is a bottom view of a surface light source of the backlight assembly illustrated in FIG. 1;

FIG. 5A is a cross-sectional view of another exemplary embodiment of a backlight assembly according to the present invention;

FIGS. 5B and 5C are cross-sectional views for explaining the operation of joining the backlight assembly illustrated in FIG. 5A;

FIG. 6 is a perspective view of the backlight assembly illustrated in FIG. 5A;

FIG. 7 is an exploded perspective view of another exemplary embodiment of a backlight assembly according to the present invention;

FIG. 8 is a perspective view of a lower substrate of a surface light source used in the backlight assembly illustrated in FIG. 7;

FIG. 9 is a cross-sectional view taken along line IX-IX′ of FIG. 7;

FIG. 10 is a cross-sectional view of another exemplary embodiment of a backlight assembly according to the present invention; and

FIG. 11 is a cross-sectional view of an exemplary embodiment of a liquid crystal display (“LCD”) according to the present invention.

### DETAILED DESCRIPTION OF THE INVENTION

The present invention will now be described more fully with reference to the accompanying drawings, in which exemplary embodiments of the present invention are shown. The present invention may, however, be embodied in many different forms and should not be construed as being limited to the exemplary embodiments set forth herein. Rather, these exemplary embodiments are provided so that this disclosure will be thorough and complete, and will fully convey the concept of the invention to those skilled in the art. In the drawings, the thickness of layers and regions are exaggerated for clarity. It will also be understood that when a layer is referred to as being “on” another layer or substrate, it can be directly on the other layer or substrate, or intervening layers may also be present. In contrast, when an element is referred to as being “directly on” another element, there are no intervening elements present.

Spatially relative terms, such as “beneath,” “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

It is noted that the use of any and all examples, or exemplary terms provided herein is intended merely to better illuminate the invention and is not a limitation on the scope of the invention unless otherwise specified. It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, an exemplary embodiment of a backlight assembly according to the present invention will be described with reference to the accompanying drawings.

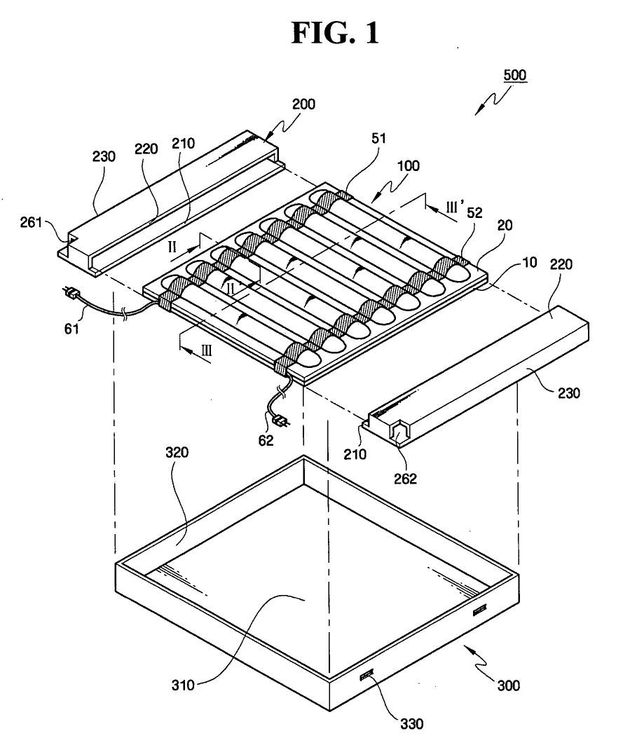

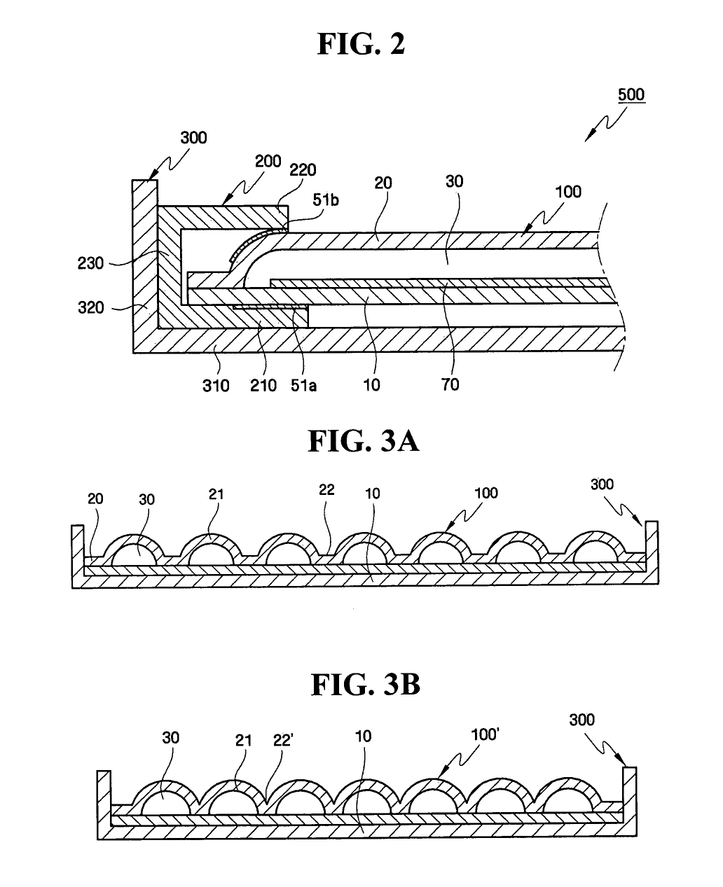

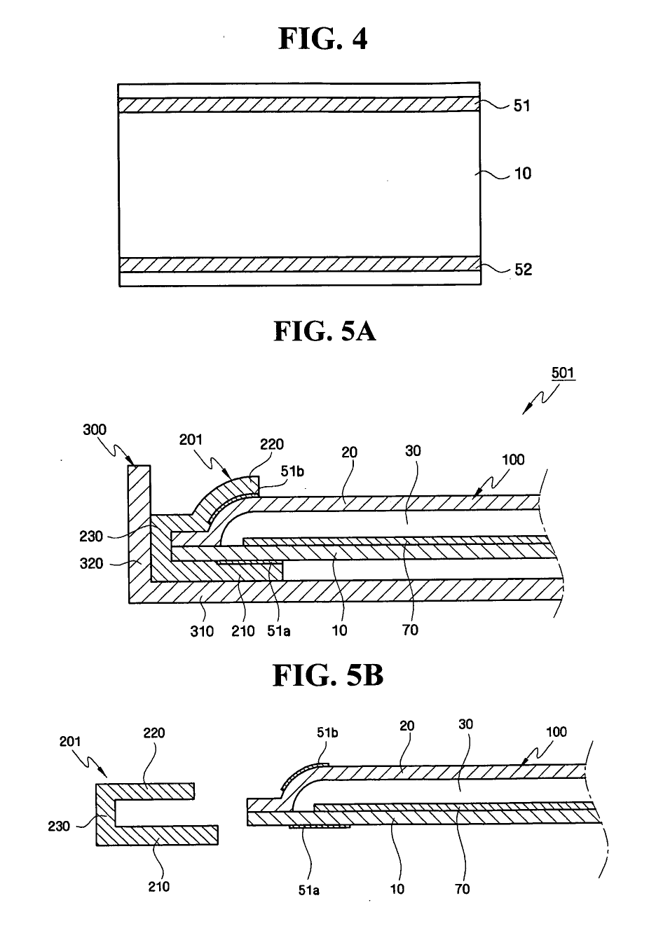

A backlight assembly according to an exemplary embodiment of the present invention includes a surface light source 100, a light source holder 200 and a bottom chassis 300 disposed below the surface light source 100. FIG. 1 is an exploded perspective view of an exemplary embodiment of a backlight assembly according to the present invention. FIG. 2 is a cross-sectional view taken along line II-II′ of FIG. 1, and FIGS. 3A and 3B are cross-sectional views taken along line III-III′ of FIG. 1. FIG. 4 is a bottom view of a surface light source of the backlight assembly illustrated in FIG. 1.

First, the surface light source 100 will be described with reference to FIGS. 1 through 4. A backlight assembly 500 includes the surface light source 100 to generate light. The surface light source 100 includes a lower substrate 10 and an upper substrate 20. The lower substrate 10 and the upper substrate 20 are joined to each other to form a chamber defining a discharge space 30. An electrode 51b is formed at a side of the upper substrate 20 and extends to a side of the lower substrate 10 corresponding to the side of the upper substrate 20.

The upper substrate 20 is made of a transparent insulating material, for example, glass. The upper substrate 20 includes a convex portion 21 and a planar portion 22, which extend in a first direction. The convex portion 21 and the planar portion 22 are alternately formed, as shown in FIGS. 1 and 3. The thickness of the upper substrate 20 at the convex portion 21 is substantially the same as the thickness thereof at the planar portion 22. The convex portion 21 is substantially separated from the lower substrate 10 and forms the discharge space 30 together with the lower substrate 10. A gas layer, such as mercury, for example, is formed in the discharge space 30.

The planar portion 22 disposed between the convex portions 21 substantially separates the discharge space 30 into a plurality of separated discharges spaces and contacts the lower substrate 10 adjacent thereto so that a leakage current between the discharge spaces 30 can be prevented.

Meanwhile, a connecting path (not shown) may be formed between the discharge spaces 30 of the convex portions 21. A uniform gas pressure between the discharge spaces 30 is maintained through the connecting path. The connecting path may be provided by forming a side of the upper substrate 20, that is, a portion of an end of the planar portion 22 in a convex shape and may be formed in a central area of the planar portion 22 if necessary.

An edge area (outer circumference), which defines a periphery of the upper substrate 20, is formed to be at the same height as the planar portion 22 so that it can be joined to the lower substrate 10 as with the planar portion 22.

FIG. 3B shows a modification of a convex pattern of the upper substrate 20. In FIG. 3B, the convex portions 21 are alternately formed, and a planar portion 22′ has a narrow width and is almost omitted altogether. Thus, each of the discharge spaces 30 may be wider than in FIG. 3A. Hereinafter, when the upper substrate 20 having the shape of FIG. 3A is shown, if the planar portion 22 having a wider width is not characteristic, the modification of FIG. 3B can also be applied to the upper substrate 20.

The lower substrate 10 is made of an insulating material such as glass, and has a flat shape. The lower substrate 10 is disposed in parallel to the upper substrate 20 and is joined to the upper substrate 20 when the outer circumference of the lower substrate 10 is joined to the outer circumference of the upper substrate 20. As such, a chamber having the discharge space 30 sealed from the outside is formed. The upper and lower substrates 20 and 10 can be joined to each other by attaching an adhesive by coating a frit glass or performing heat treatment.

A first electrode 51, which forms plasma by applying a voltage to the discharge space 30, is formed on the upper substrate 20 and on one side of the lower substrate 10 corresponding to the upper substrate 20. A second electrode 52 having the same shape as the first electrode 51 is formed on the upper substrate 20 in which the first electrode 51 is formed, and on another side of the lower substrate 10 corresponding to the upper substrate 20. For explanatory convenience, the first electrode 51 and the second electrode 52 will now be simultaneously described. In addition, even though only the first electrode 51 will be explained, if there is no special matter defined by the first electrode 51, the attributes described with respect to the first electrode 51 also apply to the second electrode 52.

Referring to FIGS. 1 and 4, the first and second electrodes 51 and 52 are formed in a second direction perpendicular to the first direction, which is a direction where the convex portion 21 of the upper substrate 20 is formed. The first and second electrodes 51 and 52 extend to the lower substrate 10 corresponding to the upper substrate 20, turn around the lower substrate 10 in the same direction, and connected to each of the first and second electrodes 51 and 52 of the upper substrate 20. That is, the first and second electrodes 51 and 52 have a shape that continuously surrounds one side of each the upper and lower substrates 20 and 10.

Electrode lines 61 and 62 are connected to the first and second electrodes 51 and 52, respectively, and the first and second electrodes 51 and 52 are electrically connected to an inverter (not shown) via the electrode lines 61 and 62. An electrode line-connecting portion (not shown) may be formed in corners of the first and second electrodes 51 and 52, for example.

The first and second electrodes 51 and 52 may be formed along the surface of the upper substrate 20 and the lower substrate 10. That is, the first and second electrodes 51 and 52 may be external electrodes formed outside the discharge space 30 defined by the upper and lower substrates 20 and 10. In this case, a dielectric material (not shown) may be coated on the surface of the first and second electrodes 51 and 52.

A phosphor material is coated on inner surfaces of the upper and lower substrates 20 and 10. The phosphor material is used to convert invisible light that is generated, when plasma generated by the first and second electrodes 51 and 52 in the discharge space 30 collides with a gas layer, into visible light. The phosphor material may be coated on inner or facing sides of the upper and lower substrates 20 and 10, that is, in an area of the discharge space 30.

A reflection layer 70 may be formed between the discharge space 30 and the lower substrate 10. The reflection layer 70 reflects the visible light generated from the phosphor material in a direction of the upper substrate 20. In this case, the phosphor material is coated on the reflection layer 70.

The principle in which visible light is emitted from the surface light source 100 will now be briefly described. If a discharge voltage from the inverter (not shown) is applied to the first electrode 51 via the electrode line 61, mercury that exists in the discharge space 30 is changed into plasma and emits invisible light, such as ultraviolet rays. The invisible light passes through the phosphor material coated on the upper and lower substrates 20 and 10 and is changed into visible light. The visible light emitted toward the upper substrate 20 passes through the upper substrate 20 and is emitted continuously. The visible light emitted toward the lower substrate 10 is reflected by the reflection layer 70 that exists between the phosphor material and the lower substrate 10 and is emitted toward the upper substrate 20 again.

Referring to FIGS. 1 and 2, the light source holder 200 covers sides of the surface light source 100 from an one end of the joined upper and lower substrates 20 and 10 and supports the surface light source 100. The light source holder 200 includes a lower support plate 210, an upper support plate 220 and a sidewall 230. The detailed description of the light source holder 200 will be described later.

The bottom chassis 300 receives the surface light source 100 and the light source holder 200 for supporting the surface light source 100. The bottom chassis 300 includes a bottom surface 310 and a sidewall 320 extending upward from the bottom surface 310. A joint 330 that is joined to a top chassis (not shown) is disposed on the sidewall 320. The sidewall 320 has a height at which the surface light source 100 and the light source holder 200 are received. For example, the height of the sidewall 320 is the same as or larger than the sum of the thickness of the surface light source 100 and the thickness of the upper and lower support plates 2200 and 210 of the light source holder 200. The bottom chassis 300 is formed of a conductive material, for example, metal, and is grounded. In addition, the bottom chassis 300 dissipates heat generated in the first and second electrodes 51 and 52 of the surface light source 100 via the light source holder 200.

An optical panel or an optical sheet (both not shown) may be disposed above the surface light source 100 and may be further received in the bottom chassis 300.

Hereinafter, the light source holder 200 will now be described with reference to FIGS. 1 and 2.

The structure of the light source holder 200 will be first described with reference to FIG. 1.

Referring to FIG. 1, the light source holder 200 includes the lower support plate 210, the upper support plate 220, and the sidewall 230 for connecting the lower support plate 210 and the upper support plate 220. The lower support plate 210 and the upper support plate 220 extend in one direction in parallel, and the sidewall 230 extends from the lower support plate 210 in a vertical direction and is connected to the upper support plate 220. The upper support plate 220 is also perpendicular to the sidewall 230. The light source holder 200 may have substantially a “U” shaped vertical cross-section. In addition, the width of the lower support plate 210 may be larger than the width of the upper support plate 220. The space defined by the upper support plate 220, the lower support plate 210 and the sidewall 230, that is, the “U” shaped vertical cross-section of the light source holder 200 shown in FIG. 1, becomes a holding space in which the light source holder 200 is joined to the surface light source 100.

In addition, an electrode line-inserting hole 261 through which the electrode line 61 of the surface light source 100 passes is formed in edges of the light source holder 200. In FIG. 1, one electrode line-inserting hole 261 for one light source holder 200 is formed in corners where the lower support plate 210 and the sidewall 230 intersect. However, the present invention is not limited to this, and the electrode line-inserting hole 261 may be formed at edges or one side where the upper support plate 220 and the sidewall 230 intersect or may perforate the sidewall 230. In addition, the number of the electrode line-inserting holes 261 is not limited to those shown in the illustrated exemplary embodiment and two or more electrode line-inserting holes may also be formed. FIG. 1 depicts electrode line-inserting holes 261 and 262 in each of the opposing light source holders 200, respectively, through which the electrode lines 61 and 62 of the surface light source 100 respectively pass.

The light source holder 200 is made of a material having good thermal conductivity and electrical insulation characteristics. In addition, the light source holder 200 may be made of a material that has elasticity so as to allow the light source holder 200 and the surface light source 100 to be easily joined to each other and to protect the surface light source 100 from external shock. The material may be a high molecular material such as silicon rubber. In this case, the high molecular material may include an additive so as to obtain good thermal conductivity.

The light source holder 200 may be manufactured by integrally forming the lower support plate 210, the upper support plate 220 and the sidewall 230. The light source holder 200 may be molded using a die having an engraved shape of the light source holder 200 through casting or injection molding, for example. In this case, when the light source holder 200 is formed of a material having elasticity, such as rubber, the dies and the molding body can be easily separated from each other.

Alternatively, the light source holder 200 can be manufactured such that the lower support plate 210, the upper support plate 220 and the sidewall 230 are separately formed and then bonded to one another. For example, a plate made of a material having good thermal conductivity and electrical insulation characteristics is cut into an appropriate size so that the lower support plate 210, the upper support plate 220 and the sidewall 230 are prepared. Subsequently, a portion of the edges of the support plates 210 and 220 and/or the sidewall 230 is cut so that the electrode line-inserting hole 261 is formed. Subsequently, the lower support plate 210, the upper support plate 220 and the sidewall 230 are bonded to one another using an adhesive, thereby completing the light source holder 200. In this case, the light source holder 200 is pressed mainly in a vertical direction, that is, in a direction parallel to the sidewall 230, so that the support plates 210 and 220 and the sidewall 230 should be firmly bonded to one another.

Next, the combination relationship between the light source holder 200, the surface light source 100 and a lower bottom chassis will be described with reference to FIG. 2.

Referring to FIG. 2, the light source holder 200 covers opposing sides of the upper substrate 20 and the lower substrate 10 of the surface light source 100. The upper support plate 220 of the light source holder 200 covers at least a portion of the upper electrode 51b of the upper substrate 20 of the surface light source 100, and the lower support plate 210 covers at least a portion of the lower electrode 51a of the lower substrate 10.

As discussed above, a large amount of heat is generated in the electrode 51 of the surface light source 100. The generated heat causes malfunction of the surface light source 100 and the liquid crystal panel assembly. The generated heat also causes deterioration in the performance of the surface light source 100 and reduces a life span thereof. In addition, an operator may get burned as a result of the generated heat. Thus, heat generated in the electrode 51 should be dissipated and cooled down. Referring to FIG. 2, the light source holder 200 covers the electrode 51 and thus, transmits heat generated in the electrode 51 to the outside. More specifically, heat generated in the electrode 51 is transmitted to the upper and lower support plates 220 and 210 of the light source holder 200 that contacts the electrode 51. Since the light source holder 200 is made of a material having good thermal conductivity, transmitted heat is rapidly dissipated to the outside, for example, to the bottom chassis 300 so that the electrode 51 can be cooled down. That is, when the light source holder 200 covers the entire portion of the upper electrode 51b and the lower electrode 51a, a cooling operation thereof can be more effectively performed.

In addition and as discussed above, since the electrode 51 of the surface light source 100 is close to the bottom chassis 300 that is made of metal, an arc may occur. An arc may cause a breakdown of the backlight assembly 500 and a liquid crystal display (LCD). In the backlight assembly 500 shown in FIG. 2, as described above, the electrode 51 of the surface light source 100 is covered by the upper and lower support plates 220 and 210 of the light source holder 200, which is made of an insulating material so that arc can be prevented. In this respect, the light source holder 200 may cover the entire portion of the upper electrode 51b and the lower electrode 51a.

Referring back to FIG. 2, an interval between the upper support plate 220 and the lower support plate 210 of the light source holder 200, that is, a distance from a lower surface of the upper support plate 220 to a top surface of the lower support plate 210 is slightly smaller than a thickness of the surface light source 100. The surface light source 100 is inserted into the light source holder 200 when the upper support plate 220 and the lower support plate 210 are spaced by a predetermined gap apart from each other upward and downward, respectively, in the holding space of the light source holder 200. Thus, due to a restorative force of the upper support plate 220 and the lower support plate 210 made of an elastic material, the side of the surface light source 100 is pressed so that the light source holder 200 and the surface light source 100 can be securely joined to each other.

The sidewall 230 of the light source holder 200 is separated from the outer circumference of the surface light source 100 by a predetermined gap, thereby forming a buffer zone that protects the surface light source 100 from a lateral pressure. When the light source holder 200 is made of a material having high elasticity, even though the outer circumference of the surface light source 100 contacts the sidewall 230 of the light source holder 200, the surface light source 100 can be protected from lateral shock. That is, a distance between the sidewall 230 of the light source holder 200 and the surface light source 100 can be properly adjusted, if necessary.

The lower support plate 210 and the sidewall 230 of the light source holder 200 are received in the bottom surface 310 and the sidewall 320, respectively, of the bottom chassis 300. The lower support plate 210 protrudes from the lower electrode 51a of the surface light source 100 by a minimum distance so that a sufficient reflection area of the reflection layer 70 disposed on the lower support plate 210 is obtained. Similarly, even in the upper support plate 220, the lower support plate 210 has a proper width so as to obtain the maximum emission area of the surface light source 100 and protrudes from the upper electrode 51b of the surface light source 100 by a minimum distance.

In addition, one side or one end portion of the surface light source 100 is supported by the lower support plate 210 of the light source holder 200 and the bottom chassis 300 disposed under the lower support plate 210. However, a central area of the surface light source 100 is separated from the bottom chassis 300 by the thickness of the lower support plate 210 or a thickness smaller than the lower support plate 210 and becomes a buffer zone that protects the surface light source 100 from an external longitudinal shock. In this case, in order to prevent the central area of the surface light source 100 from being excessively bent and to obtain a sufficient buffer zone, the lower support plate 210 may have at least a suitable width to prevent excessive bending and provide a sufficient buffer zone. In consideration of the above-described reflection area and emission area, the width of the lower support plate 210 may be larger than the width of the upper support plate 220, as illustrated.

Hereinafter, a method of joining the surface light source 100, the light source holder 200 and the bottom chassis 300 will now be described.

First referring to FIGS. 1 and 2, the electrode line 61 of the surface light source 100 is inserted into the outside from the holding area of the light source holder 200 through the electrode line-inserting hole 261 of the light source holder 200, and the light source holder 200 is joined to both sides of the surface light source 100 in which the electrode line 61 is formed. Subsequently, the surface light source 100 joined to the light source holder 200 is disposed on the bottom surface 310 of the bottom chassis 300. In the joining operation, since the light source holder 200 and the surface light source 100 are joined from the outside before they are joined to the bottom chassis 300, compared to a conventional method in which the light source holder 200 is disposed on the bottom chassis 300 and the surface light source 100 is joined to the light source holder 200 disposed on the bottom chassis 300, there is little probability of joining errors such as entangled edges. Thus, a joining speed is faster than in the conventional method, so that the entire process efficiency can be improved.

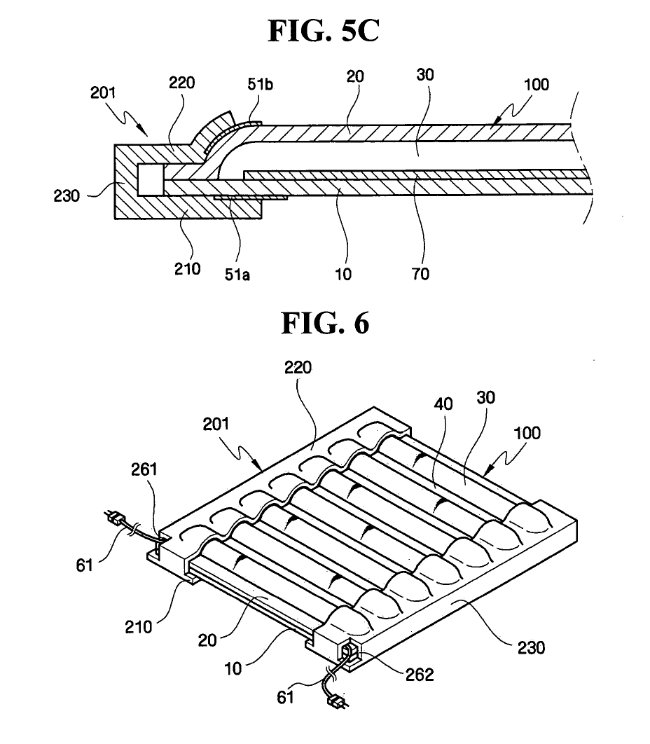

Hereinafter, another exemplary embodiment of a backlight assembly according to the present invention will now be described with reference to FIGS. 5A through 5C. FIG. 5A is a cross-sectional view of another exemplary embodiment of a backlight assembly according to the present invention, and FIGS. 5B and 5C are cross-sectional views for explaining the operation of joining the backlight assembly illustrated in FIG. 5A.

Referring to FIG. 5A, in a backlight assembly 501, a side of the surface light source 100 having the electrode 51 is closely adhered to a light source holder 200. The light source holder 201 is closely adhered to the surface light source 100 along the side of the surface light source 100 and covers the surface light source 100 and the electrode 51. The upper support plate 220 of the light source holder 201 covers a portion of the discharge space 30 along a profile of the discharge space 30, which is a convex area of the surface light source 100. The light source holder 201 may be formed of a material having elasticity. A restorative force is generated in the light source holder 201 that allows the upper support plate 220 to resiliently lean or displace backwards in a convex shape on the discharge space 30 by elasticity so that the surface light source 100 is pressed. Thus, the surface light source 100 can be more securely supported by the light source holder 201.

FIG. 5B is a cross-sectional view of a light source holder before the light source holder 201 is joined to the surface light source 100. Referring to FIG. 5B, the height of the sidewall 230 of the light source holder 201 is smaller than the sidewall 230 of the light source holder illustrated in FIG. 1. The height of the holding space, that is, a distance between inner surfaces of the upper support plate 220 and the lower support plate 210 of the light source holder 201, is substantially the same as the thickness of the outer circumference of the surface light source 100, that is, the sum of the thicknesses of the upper support plate 220 and the lower support plate 210.

FIG. 5C shows an operation of joining the surface light source and the light source holder.

Referring to FIG. 5C, when the surface light source 100 is inserted into the holding space of the light source holder 201, since the thickness of the outer circumference of the surface light source 100, corresponding to an insertion entrance part, is substantially the same as the height of the holding space, the surface light source 100 is easily pulled and inserted into the holding space of the light source holder 201 during the initial stage of insertion. Then, when the upper support plate 220 of the light source holder 201 contacts the convex surface of the surface light source 100, the upper support plate 220 is displaced backwards along the convex surface of the surface light source 100. Referring to FIG. 5A, a large force is applied to the upper support plate 220 so that the corresponding side of the surface light source 100 is closely adhered to the sidewall 230 of the light source holder 201. In this case, when the hardness of the light source holder 201 is high and the upper support plate 220 is displaced upwards, if the upper support plate 220 makes minimal contact with a portion of the upper electrode 51b of the surface light source 100, sufficient thermal conduction effect cannot be realized. To prevent this problem, the light source holder 201 can be made of a material having elasticity and low hardness.

FIG. 6 is a perspective view of the backlight assembly illustrated in FIG. 5A.

Referring to FIG. 6, the upper support plate 220 of the light source holder 201 that overlaps the surface light source 100 has a conformal shape along the profile of the surface light source 100. Thus, the surface light source 100 is prevented from moving relative to the light source holder 201 and is securely supported thereby.

Furthermore, in FIG. 6, the two electrode lines 61 and 62 are drawn to the outside of the respective light source holders 201 through the respective electrode line-inserting holes 261 and 262 formed in both corners of the light source holders 201. If necessary, two electrode lines 61 and 62 may pass through the electrode line-inserting holes 261 and 262 and may be combined with one plug. The combination relationship between the electrode lines 61 and 62 and the electrode line-inserting holes 261 and 262 shown in FIG. 6 can also be applied to the exemplary embodiment shown in FIG. 1 and other alternative exemplary embodiments of the present invention, which will be described later.

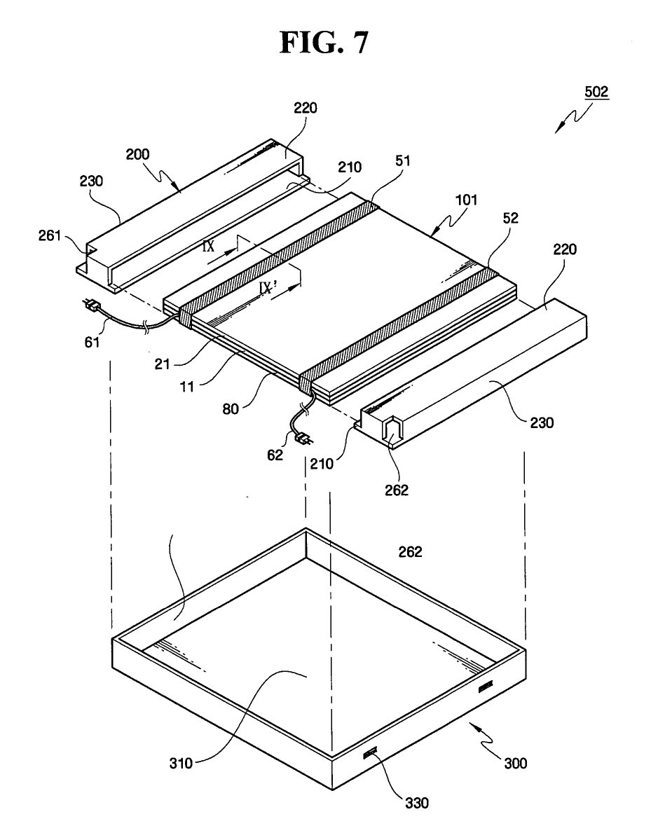

Next, another exemplary embodiment of a backlight assembly according to the present invention will be described with reference to FIGS. 7 through 9.

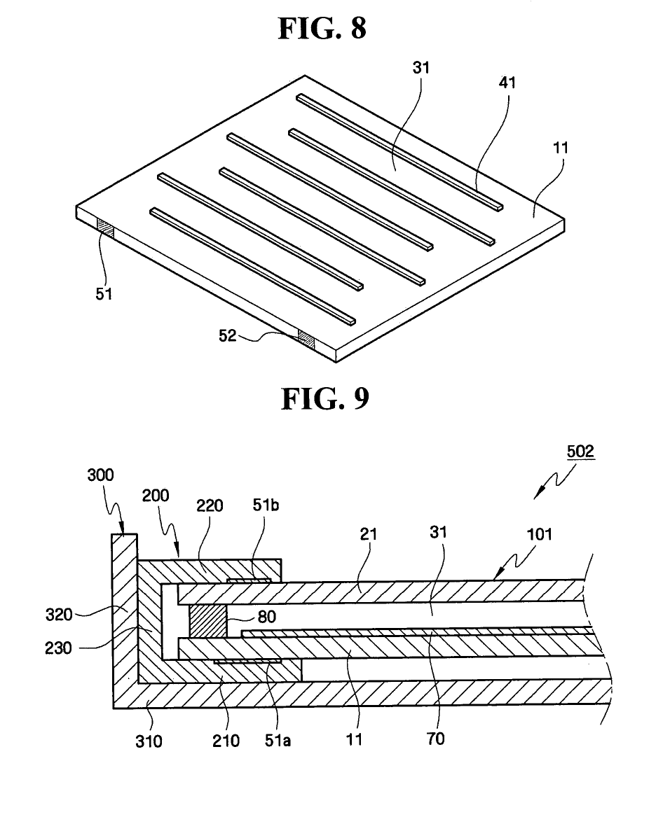

FIG. 7 is an exploded perspective view of another exemplar embodiment of a backlight assembly according to the present invention. FIG. 8 is a perspective view of a lower substrate of a surface light source used in the backlight assembly illustrated in FIG. 7 and FIG. 9 is a cross-sectional view taken along line IX-IX′ of FIG. 7.

Referring to FIGS. 7 and 9, the upper substrate 21 of the surface light source 101 used in a backlight assembly 502 is not formed in a convex pattern, but has an overall flat shape. A rectangular sealing member 80 is disposed between the upper substrate 21 and the lower substrate 11. The upper and lower substrates 21 and 11 are directly attached to the sealing member 80 made of frit glass or may be joined by forming a bonding layer made of frit glass or using an adhesive above and below the sealing member 80 made of glass.

Referring to FIG. 8, the lower substrate 11 of the surface light source 101 includes at least one barrier rib 41 that extends in a first direction. The height of the barrier rib 41 is the same as the thickness of the sealing member 80 or the sum of the thicknesses of the sealing member 80 and the bonding layer so that the discharge space 31 is separated from the barrier ribs 41. One end of the barrier rib 41 is attached to the sealing member 80, and a connecting path for maintaining a gas pressure between the discharge spaces 31 is formed in a portion of the barrier rib 41 at an opposite end. Referring to FIG. 8, the connecting path is formed on one end of the barrier rib 41, and a connecting path is formed on another end of an adjacent barrier rib 41 thereto. That is, the barrier rib 41 is disposed in a serpentine shape.

Referring to FIG. 9, since the upper substrate 21 of the surface light source 101 is formed in a flat shape, a light source holder 200 covers the surface light source 101 and the electrode 51 while keeping substantially a “U” shape excluding a portion that covers the electrode 51. The height of the holding space of the light source holder 200 is the same as the thickness of the surface light source 101. If the height of the holding space is larger than that of the surface light source 101, the electrode 51 and the light source holder 200 may not contact each other. If the height of the holding space is smaller than that of the surface light source 101, the upper support plate 220 leans upwards. In this case, unlike FIGS. 5A through 5C, since the upper substrate 21 has a flat shape, it is difficult to conformally join the upper support plate 220 to the upper substrate 21. Thus, a distance between inner surfaces of the upper support plate 220 and the lower support plate 210 of the light source holder 200 may be the same as or smaller than the sum of thicknesses of the upper substrate 21, the lower substrate 11 and the sealing member 80 disposed therebetween of the surface light source 101.

In addition as illustrated in FIG. 9, the side of the surface light source 101 is distant from the sidewall 230 of the light source holder 200, but may be closely adhered thereto, if necessary.

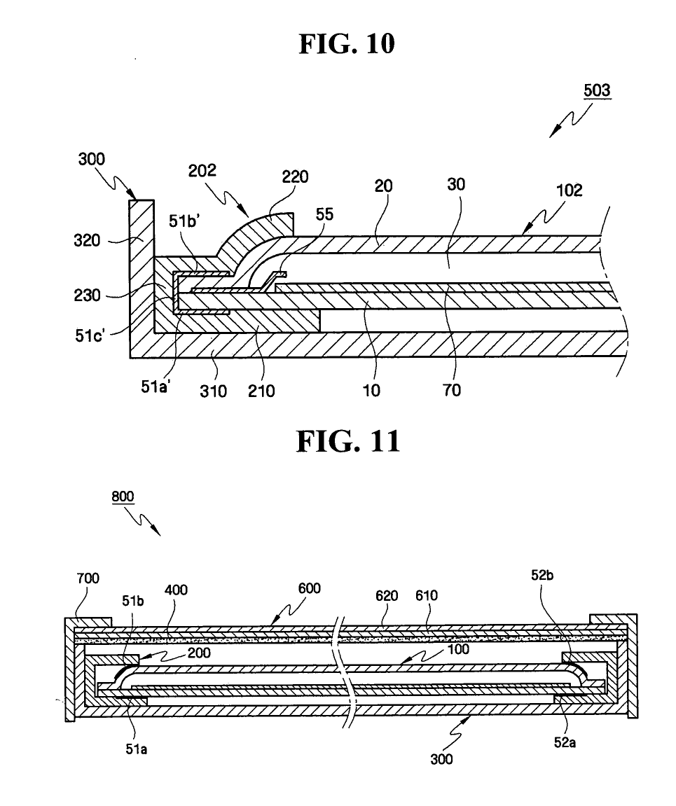

Next, another exemplary embodiment of a backlight assembly according to the present invention will now be described with reference to FIG. 10. FIG. 10 is a cross-sectional view of another exemplary embodiment of a backlight assembly according to the present invention.

Referring to FIG. 10, in a surface light source 102 used in a backlight assembly 503, electrodes 51b′ and 51a′ formed on the sides of the upper substrate 20 and the lower substrate 10, respectively, are connected by a side electrode 51c′ that extends in a direction of the side of the surface light source 102 and is substantially parallel with sidewall 230. That is, the electrodes 51a′, 51b′ and 51c′ surround the side of the surface light source 102. In addition, a floating electrode 55 is formed in the discharge space 30 of the surface light source 102.

It will be recognized that the surface light source 102 in all of the exemplary embodiments described herein may be defined as having a central area intermediate two opposing “sides” of the surface light source 102. In this manner, a “side” of the light source 102 is defined as the terminal edges of joined substrates 10 and 20 as well as the corresponding opposing surfaces of the joined substrates extending toward the central area from a respective terminal edge of substrates 10 and 20.

Since the electrodes 51a′, 51b′ and 51c′ are formed on the lower substrate 10, the upper substrate 20 and at the side of the surface light source 102, a lamp holder 202 is closely adhered to the side of the surface light source 102, as shown in FIG. 5A. That is, the sidewall 230 of the lamp holder 202 is closely adhered to the side electrode 51c′ of the surface light source 102 so that heat generated in the side electrode 51c′ can be dissipated.

The backlight assembly illustrated in FIGS. 1, 5A, 7, and 10 can be applied to an LCD. An exemplary embodiment of an LCD according to the present invention will now be described with reference to FIG. 11. FIG. 11 is a cross-sectional view of an exemplary embodiment of a liquid crystal display (“LCD”) 800 according to the present invention.

The LCD 800 includes a backlight assembly 500 (FIG. 1) and a liquid crystal panel assembly 600. The backlight assembly 500 is the same as the backlight assembly illustrated in FIG. 1. The backlight assembly 500 may further include at least one optical sheet 400 for improving the characteristic of light emitted from the surface light source 100. The optical sheet 400 may include a diffusion sheet for diffusing light or a prism sheet for condensing light.

The liquid crystal panel assembly 600 includes liquid crystal panels 610 and 620 for displaying an image, and a data and gate printed circuit board (“PCB”) (not shown) for providing driving signals for driving the liquid crystal panels 610 and 620. The data and gate PCB is electrically connected to the liquid crystal panels 610 and 620 via a tape carrier package (“TCP”) (not shown).

The liquid crystal panels 610 and 620 include a first plate or panel 610 having thin film transistors (“TFTs”) and pixel electrodes (both not shown), a second plate or panel 620 which faces the first plate 610 and includes a common electrode (not shown), and a liquid crystal layer (not shown) interposed between the first and second plates 610 and 620.

The TFTs as switching elements are arranged in a matrix form in the first plate 610. Data lines and gate lines are connected to source and gate terminals of the TFTs, respectively, and pixel electrodes, made of a transparent conductive material, are connected to drain terminals.

Color filters (not shown) producing red, green and blue light are alternately disposed in the second plate 620, and black matrix patterns (not shown) are formed between the color filters. The common electrode, made of a transparent conductive material, is formed on the color filters.

The LCD 800 may further include a top chassis 700, which surrounds the sides of the liquid crystal panels 610 and 620, and is joined to the bottom chassis 300. The top chassis 700 prevents the liquid crystal panels 610 and 620 from being damaged due to external impacts and the liquid crystal panels 610 and 620 from deviating from their proper positions.

As described above, according to exemplary embodiments of the backlight assembly of the present invention, a light source can be supported and protected from external impacts, heat generated from an electrode of the light source is dissipated and cooled down so that breakdown and malfunction of the backlight assembly and the LCD caused by overheating can be prevented. In addition, an insulating material is interposed between the electrode and a bottom chassis so that breakdown and malfunction caused by an arc can be prevented.

As described above, one-side cross-section of a portion of various cross-sectional views for explaining exemplary embodiments of the present invention is omitted for convenient explanation, but the omitted other-side cross-section thereof may have the same symmetrical shape. In addition, the above-described exemplary embodiments can be combined with one another or with well-known technology.

While the present invention has been particularly shown and described with reference to exemplary embodiments thereof, it will be understood by those skilled in the art that various changes in form and details may be made thereto without departing from the spirit and scope of the invention as defined by the following claims and equivalents thereof.

What is claimed is:

1. A backlight assembly comprising:
a surface light source including a lower substrate, an upper substrate joined to an outer circumference of the lower substrate and forming a discharge space, and an electrode formed on the joined upper and lower substrates; and
at least one light source holder including an upper support plate, a lower support plate, and a sidewall for connecting the upper support plate and the lower support plate, and covering the electrode formed on the joined upper and lower substrates from a side of the joined upper and lower substrates.

2. The backlight assembly of claim 1, wherein the light source holder covers the entire portion of the electrode.

3. The backlight assembly of claim 1, wherein the light source holder has a substantially “U” shaped vertical cross-section.

4. The backlight assembly of claim 3, wherein a width of the lower support plate of the light source holder is larger than a width of the upper support plate thereof.

5. The backlight assembly of claim 1, wherein the light source holder is made of a thermal conductive insulating material.

6. The backlight assembly of claim 1, wherein the light source holder is made of an insulating material having elasticity.

7. The backlight assembly of claim 1, wherein the light source holder is closely adhered to the surface light source along a step difference of a side of the surface light source in which the electrode is formed.

8. The backlight assembly of claim 1, wherein the electrode is an external electrode formed on an outer surface of the surface light source.

9. The backlight assembly of claim 8, wherein the light source holder contacts the electrode formed on the upper and lower substrates.

10. The backlight assembly of claim 1, further comprising a bottom chassis including a bottom surface and a sidewall that vertically extends from an outer circumference of the bottom surface, the bottom chassis disposed below the surface light source and the light source holder and receiving the surface light source and the light source holder.

11. The backlight assembly of claim 10, wherein the light source holder contacts the bottom surface and the sidewall of the bottom chassis.

12. The backlight assembly of claim 1, wherein the light source holder includes at least one electrode line-inserting hole.

13. The backlight assembly of claim 1, wherein at least the upper substrate of the light source holder is made of a material having elasticity and low hardness sufficient to allow conformal shape of at least the upper substrate along the profile of the surface light source 100.

14. A liquid crystal display comprising:
a backlight assembly comprising a surface light source including a lower substrate, an upper substrate joined to an outer circumference of the lower substrate and forming a discharge space, and an electrode formed on the joined upper and lower substrates; at least one light source holder including an upper support plate, a lower support plate, and a sidewall for connecting the upper support plate and the lower support plate, and covering the electrode formed on the joined upper and lower substrates from a side of the joined upper and lower substrates, and a bottom chassis receiving the surface light source and the light source holder and disposed below the surface light source; and
a liquid crystal panel assembly displaying an image using light emitted from the backlight assembly.

15. The liquid crystal display of claim 14, wherein the light source holder covers the entire portion of the electrode.

16. The liquid crystal display of claim 14, wherein the light source holder has a substantially “U” shaped vertical cross-section.

17. The liquid crystal display of claim 16, wherein a width of the lower support plate of the light source holder is larger than a width of the upper support plate thereof.

18. The liquid crystal display of claim 14, wherein the light source holder is made of a thermal conductive insulating material.

19. The liquid crystal display of claim 14, wherein the light source holder is made of an insulating material having elasticity.

20. The liquid crystal display of claim 14, wherein the light source holder is closely adhered to the surface light source along a step difference of a side of the surface light source in which the electrode is formed.

21. The liquid crystal display of claim 14, wherein the electrode is an external electrode formed on an outer surface of the surface light source.

22. The liquid crystal display of claim 21, wherein the light source holder contacts the electrode formed in the upper and lower substrates.

23. The liquid crystal display of claim 21, wherein the bottom chassis includes a bottom surface and a sidewall that vertically extends from an outer circumference of the bottom surface.

24. The liquid crystal display of claim 23, wherein the light source holder contacts the bottom surface and the sidewall of the bottom chassis.

25. The liquid crystal display of claim 21, wherein the light source holder includes at least one electrode line-inserting hole.

26. The backlight assembly of claim 14, wherein at least the upper substrate of the light source holder is made of a material having elasticity and low hardness sufficient to allow conformal shape of at least the upper substrate along the profile of the surface light source.
